(19) United States
(12) Patent Application Publication
(10) Pub. No.: US 2007/0133083 A1
(43) Pub. Date: Jun. 14, 2007

(54) WAVEGUIDE APPARATUS WITH INTEGRATED AMPLIFIER AND ASSOCIATED TRANSITIONS

(76) Inventors: Pekka P. Kangaslahti, Los Angeles, CA (US); Erich T. Schlecht, Pasadena, CA (US); Lorene A. Samoska, La Canada, CA (US)

Correspondence Address: Zilka-Kotab, PC, P.O. BOX 721120, SAN JOSE, CA, 95172-1120, US

(21) Appl. No.: 11/567,143

(22) Filed: Dec. 5, 2006

Related U.S. Application Data
(60) Provisional application No. 60/748,186, filed on Dec. 7, 2005.

(51) Int. Cl. H01S 3/00

(52) U.S. Cl. 359/337

(57) ABSTRACT

An waveguide apparatus and associated method are provided. Included is a waveguide and an integrated circuit positioned, at least in part, in the waveguide. The integrated circuit includes an amplifier and at least one transition between the amplifier and the waveguide.

### RELATED APPLICATION(S)

The present application claims the benefit of a provisional application filed on Dec. 7, 2005 under application Ser. No. 60/748,186, which is incorporated herein by reference in its entirety for all purposes.

### STATEMENT REGARDING FEDERALLY SPONSORED RESEARCH OR DEVELOPMENT

The invention described herein was made in the performance of work under a NASA contract, and is subject to the provisions of Public Law 96-517 (35 USC 202) in which the Contractor has elected to retain title.

### FIELD OF THE INVENTION

The present invention relates to waveguides, and more particularly to integrating amplifiers with waveguides.

### BACKGROUND

Waveguides are typically used to guide signals through an associated structure. Various separate circuitry has traditionally been used to process the signals traveling via the waveguide. One example of such circuitry includes amplifiers which have typically been utilized to amplify such signals during use.

In general, integrated circuits and, in particular, transistors are continuously being reduced in size and are thus becoming faster and faster. By virtue of this increase in speed, resultant circuitry such as the aforementioned amplifiers is capable of operating at higher frequencies. Such higher frequencies, however, are typically accompanied by increased parasitic effects, etc.

Specifically, in the context of waveguides, these parasitic effects are exacerbated by various structures (e.g. bond wires, interconnects, via holes, etc.) that may reside between the waveguide and an associated amplifier. In use, such effects may negatively impact a performance of the amplifier, resulting in reduced gain, etc. Even still, as a collateral issue, the aforementioned structures typically add to the overall cost of the waveguide/amplifier system.

There is thus a need for overcoming these and/or other issues associated with the prior art.

### SUMMARY

An waveguide apparatus and associated method are provide. Included is a waveguide and an integrated circuit positioned, at least in part, in the waveguide. The integrated circuit includes an amplifier and at least one transition between the amplifier and the waveguide. By virtue of such integration, a reduction in cost and/or parasitic effects, and/or improved performance may be realized, in some possible embodiments.

### BRIEF DESCRIPTION OF THE DRAWINGS

FIG. 1 illustrates an apparatus including a waveguide with an integrated circuit positioned therein at least in part, in accordance with one embodiment.

FIG. 2 illustrates an apparatus including a waveguide with a plurality of integrated circuits positioned in a side-by-side relationship, in accordance with another embodiment.

FIG. 3 illustrates an apparatus including a waveguide with a plurality of cascaded integrated circuits positioned therein, in accordance with another embodiment.

FIG. 4 illustrates an integrated circuit for positioning in a waveguide, in accordance with another embodiment.

FIG. 5 is a side cross-sectional view of a multi-conductor transmission line for impedance matching purposes taken along line 5-5 shown in FIG. 4, in accordance with an optional embodiment.

FIG. 6 is a perspective view of electromagnetic waves present during use of a waveguide with an amplifying integrated circuit positioned therein, in accordance with one embodiment.

FIG. 7 is a schematic diagram of circuitry for amplifying signals in the context of a waveguide, in accordance with another embodiment.

FIG. 8 is a schematic diagram of circuitry for amplifying signals in the context of a waveguide, in accordance with yet another embodiment.

FIG. 9 is a perspective view of electromagnetic waves present during use of a waveguide with an amplifying integrated circuit positioned therein, in accordance with one embodiment.

FIG. 10 illustrates a graph showing operational results for a single stage amplifier, in accordance with one embodiment.

FIG. 11 illustrates a graph showing operational results for a single stage amplifier, in accordance with another embodiment.

FIG. 12 illustrates a graph showing operational results for two cascaded 180 GHz integrated circuits, in accordance with yet another embodiment.

FIG. 13 illustrates a graph showing operational results for parallel-mounted integrated circuits, in accordance with another embodiment.

FIG. 14 illustrates a graph showing operational results for two cascaded 280 GHz integrated circuits, in accordance with yet another embodiment.

### DETAILED DESCRIPTION

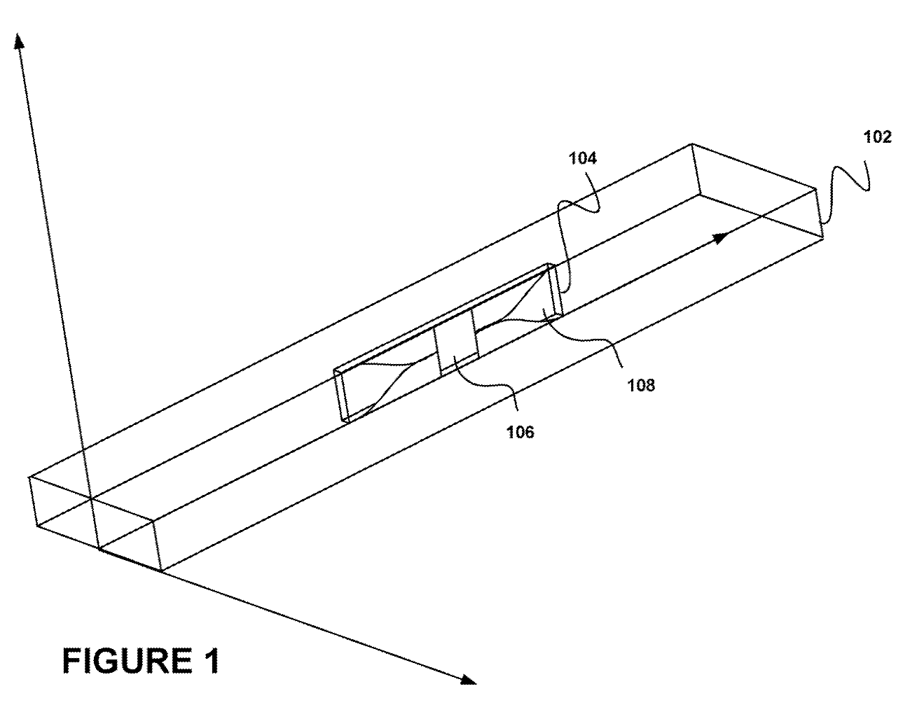

FIG. 1 illustrates an apparatus 100 including a waveguide 102 with an integrated circuit 104 positioned therein at least in part, in accordance with one embodiment. While the waveguide 102 is shown to be rectangular, it should be noted that the waveguide 102 may take any form (e.g. circular etc.). For that matter, in the context of the present description, the term waveguide may refer to any structure that is capable of guiding electromagnetic signal. In FIG. 1, the integrated circuit 104 is positioned completely within the waveguide 102. However, it is contemplated that, in other embodiments, the integrated circuit 104 may only be partially positioned in the waveguide 102.

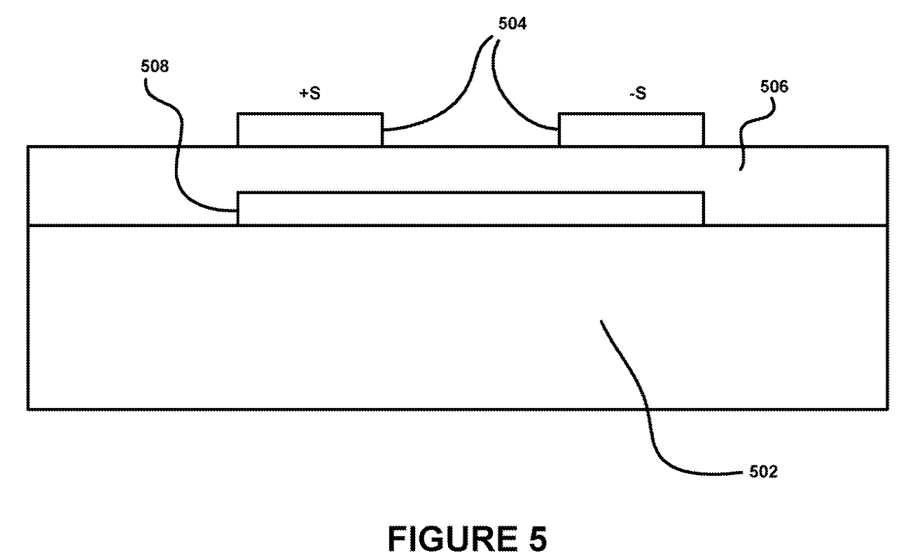

As further shown, the integrated circuit 104 includes at least one amplifier 106. In the context of the present description, the amplifier 106 may include any circuitry capable of amplifying a received signal. In various exemplary embodiments, the amplifier 106 may include a differential amplifier including one, two, or more differentially configured transistor pairs. In still additional embodiments, the foregoing transistors may be configured with a virtual radio frequency (RF) ground. More information regarding a different embodiment embodying such a virtual ground will be set forth during reference to FIG. 5.

Further, in additional embodiments, the amplifier 106 may accommodate waves of different sizes, such that the amplifier 106 takes the form of a millimeter wave amplifier, sub-millimeter wave amplifier, etc. thus constituting a monolithic microwave integrated circuit (MMIC). In still yet another embodiment, the amplifier 106 may be an indium phosphide high electron mobility transistor (InP-HEMT) amplifier. Of course, such example of amplifiers set forth for illustrative purposes only, since any amplifier that meets the abovementioned definition may be employed. Further, such amplifier 106 may optionally be supplemented and/or substituted circuits (e.g. mixers, phase shifters, multiplexers, etc.)

With continuing reference to FIG. 1, the integrated circuit 104 is also illustrated to include at least one transition 108 between the amplifier 106 and the waveguide 102. Specifically, in the embodiment shown, a pair of transitions 108 may be positioned on the integrated circuit 104 between an input and output of the amplifier 106, and the waveguide 102. Of course, in the context of the present description, such transitions may take the form of any structure that channels the aforementioned signal between the amplifier 106 and the waveguide 102. Just by way of example, in various embodiments, the transitions 108 may include a finline transition, a slotline transition and/or any other transition (e.g. microstrip, stripline, coplanar, etc.), for that matter.

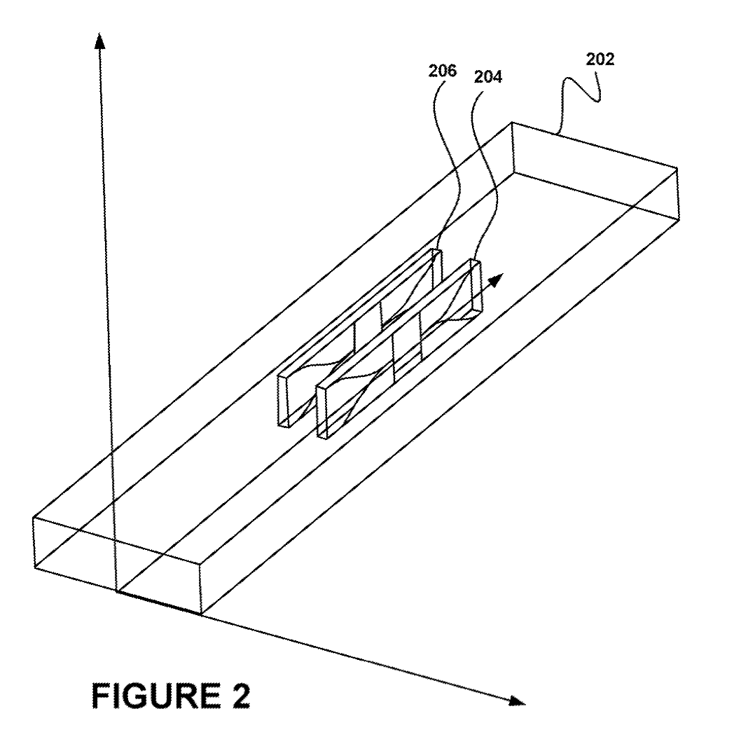

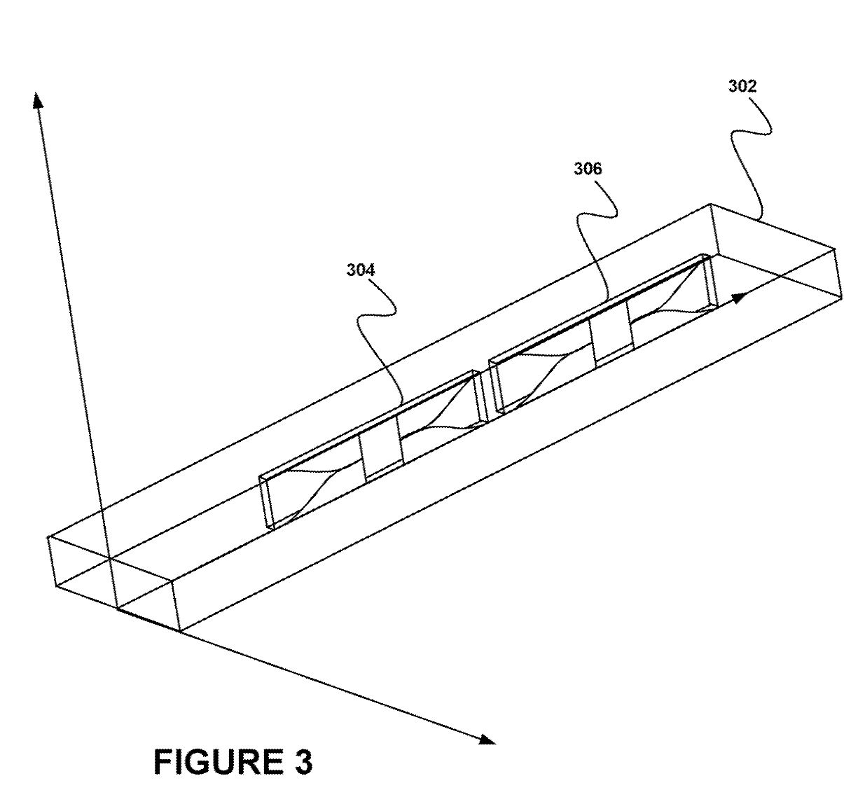

In the present illustrated embodiment, the integrated circuit 104 is positioned in an E-plane of the waveguide 102. Of course, other positions are contemplated. Further, while only a single integrated circuit 104 is shown to be positioned in the waveguide 102, other embodiments are contemplated where multiple integrated circuits 104 are positioned in the waveguide 102. Such embodiments will be described hereinafter in greater detail during reference to FIGS. 2 and 3.

More illustrative information will now be set forth regarding various optional architectures and features of different embodiments with which the foregoing technique may or may not be implemented, per the desires of the user. It should be strongly noted that the following information is set forth for illustrative purposes and should not be construed as limiting in any manner. Any of the following features may be optionally incorporated with or without the other features described.

For example, by virtue of the above-described integration, a reduction in cost and/or parasitic effects (e.g. wirebond inductance, cavity mode resonance, etc.), and/or improved performance may be realized, in various embodiments. For instance, in some embodiments, the aforementioned features may result in an increase in intrinsic gain. Further, in other embodiments, a wirebonded interconnect microstrip inductive vias to ground, and/or other structures need not necessarily be required to provide a transition to the waveguide. Still yet, in other embodiments, grounding of the foregoing amplifier may be avoided, particularly at sub-millimeter frequencies where such grounding is difficult due to the inductance and physical size of substrate vias, etc. Even still, the amplifier may operate at elevated frequencies such as frequencies greater than 150 GHz, 180 GHz, 200 GHz and even 300 GHz. Of course, lower frequency operation (e.g. 60, 70 GHz, etc.) is also contemplated.

FIG. 2 illustrates an apparatus 200 including a waveguide 202 with a plurality of integrated circuits 204, 206 positioned in a side-by-side relationship, in accordance with another embodiment. As an option, the waveguide 202 and integrated circuits 204, 206 may include the various features of those set forth in the context of the apparatus 100 of FIG. 1. Of course, however, it should be noted that such components may take any form. Further, the definitions provided above may equally apply to the present description.

As shown in FIG. 2, the integrated circuits 204, 205 include a first integrated circuit 204 and a second integrated circuit 206 which are positioned in a side-by-side relationship. While only two integrated circuits 204, 206 are shown, more integrated circuits 204, 206 are, of course, contemplated, in the context of other embodiments.

In the embodiment shown, such integrated circuits 204, 206 are centrally positioned in the waveguide 202 coincident with spaced Y-planes. Specifically, the second integrated circuit 206 is placed slightly offset from a center of the waveguide 202 in parallel with the first integrated circuit 204. This design does not necessarily change the impedance match with respect to the waveguide 202.

An amplifier of the second integrated circuit 206 receives a signal from the waveguide 202 in the same phase and amplitude as an amplifier of the first integrated circuit 204, and amplifies such signal in parallel with the amplifier of the first integrated circuit 204. In one embodiment, a gain of the amplifiers of the integrated circuits 204, 206 may be identical to that of a single waveguide amplifier (e.g. see FIG. 1, etc.). The present apparatus 200, however, is able to combine the maximum output power of the amplifiers of both integrated circuits 204, 206 in a highly efficient manner. Thus, a maximum output power may reach twice that of a single amplifier.

FIG. 3 illustrates an apparatus 300 including a waveguide 302 with a plurality of cascaded integrated circuits 304, 306 positioned therein, in accordance with another embodiment. As an option, the waveguide 302 and integrated circuits 304, 306 may include the various features of those set forth in the context of the remaining figures. Of course, however, it should be noted that such components may take any form. Further, the definitions provided above may equally apply to the present description.

As shown in FIG. 3, the integrated circuits 304, 306 are cascaded. Specifically, in the embodiment shown, such integrated circuits 304, 306 are centrally positioned in the waveguide 302 in an end-to-end relationship within a single Y-plane. Similar to the previous embodiment, while only two integrated circuits 304, 306 are shown, more integrated circuits 304, 306 are, of course, contemplated, in the context of other embodiments.

In various embodiments, any interconnecting wirebonds or substrates between the integrated circuits 304, 306 may be avoided, since the waveguide 302 may serve as a connecting media (thereby increasing efficiency). As an option, any cavities between the integrated circuits 304, 306 may be filled with indium for improving contact with adjacent waveguide walls. Further, since a wavelength between amplifiers of the integrated circuits 304, 306 is fractions of a wavelength, band ripple may also be reduced/minimized. In use, an amplifier of the second integrated circuit 306 may be placed in cascade with an amplifier of the first integrated circuit 304. Thus, the amplifier of the second integrated circuit 306 receives an amplified signal from the amplifier of the first integrated circuit 304, and further amplifies the same. To this end, the present apparatus 300 may exhibit, in some embodiments, twice the gain of a single amplifier embodiment (e.g. FIG. 1, etc.).

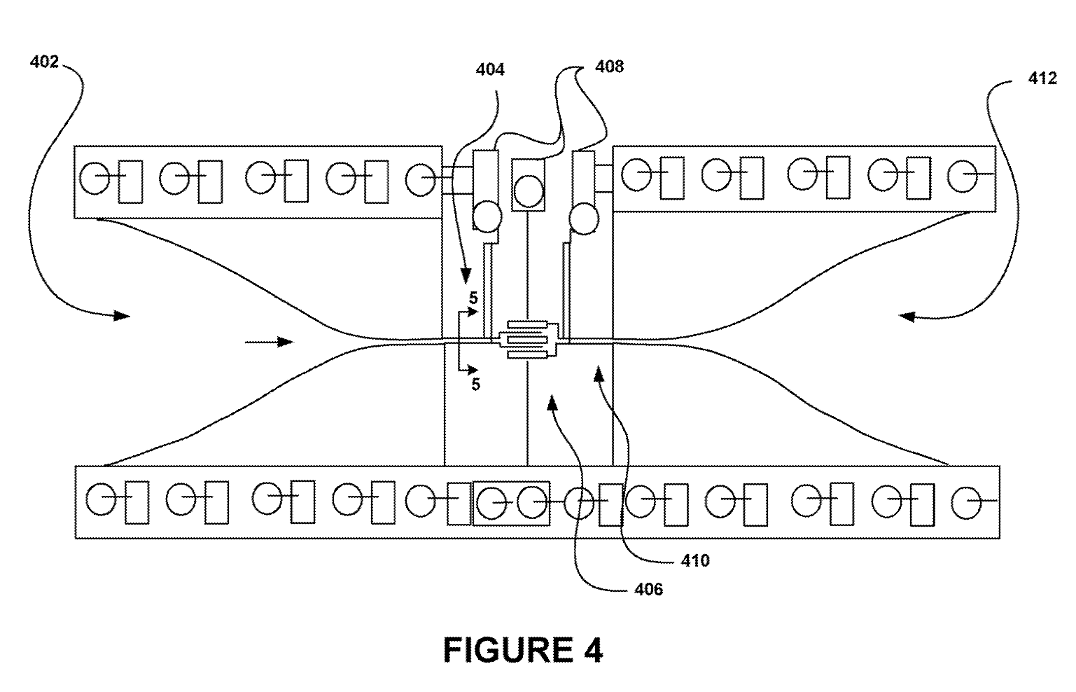

FIG. 4 illustrates an integrated circuit 400 for positioning in a waveguide, in accordance with another embodiment. As an option, the integrated circuit 400 may include the various features of the integrated circuits set forth in the remaining figures. Of course, however, it should be noted that, in various embodiments, the integrated circuit 400 may be used in any desired environment. Further, the definitions provided above may equally apply to the present description.

As shown, the integrated circuit 400 includes an input transition 402 that feeds electromagnetic waves (not shown) from a waveguide (not shown) to input impedance matching circuitry 404 that remains in communication with the input transition 402. In the present embodiment, the input impedance matching circuits 404 may include a multi-conductor transmission line that performs impedance transformation to match an input of a differential amplifier 406 coupled to the input impedance matching circuitry 404. While such impedance matching circuitry 404 may take any form for serving the foregoing function, one particular embodiment for accomplishing the same will be set forth in greater detail during reference to FIG. 5.

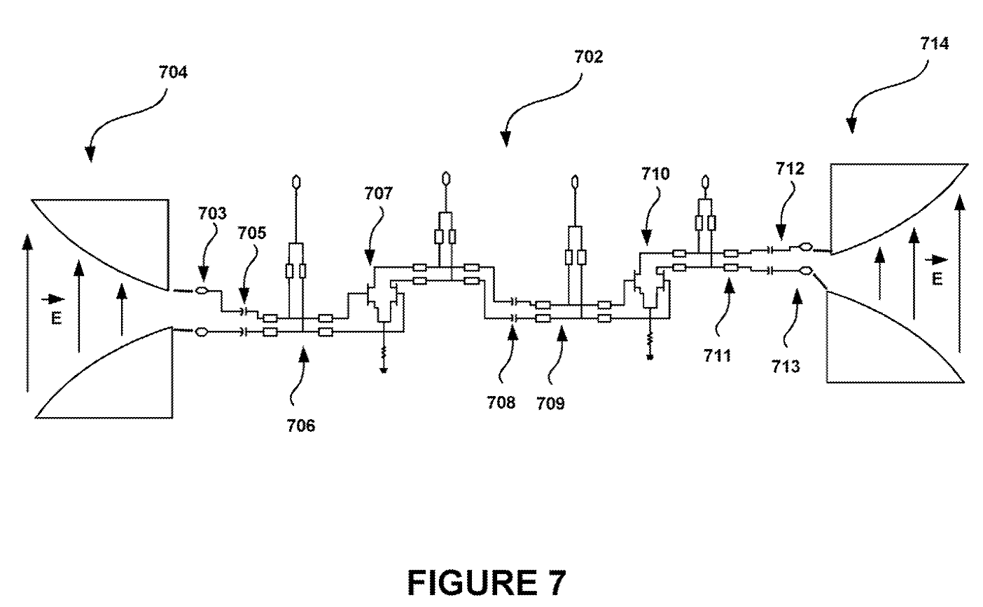

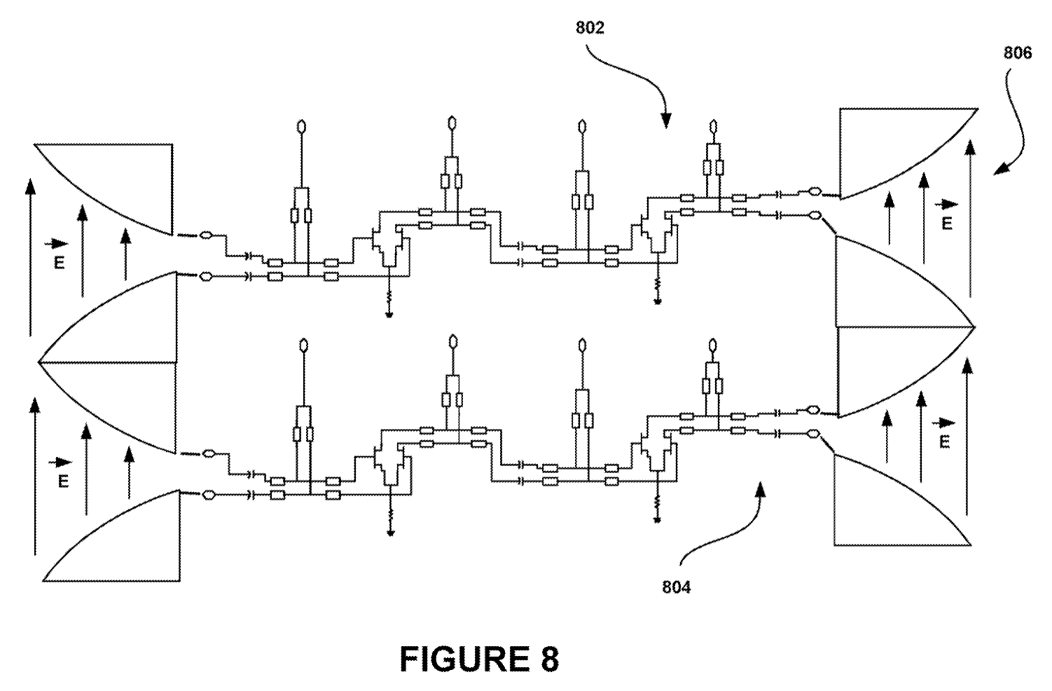

While the differential amplifier 406 may take any form, it may, in the present embodiment, include a plurality of differential transistor pairs (not shown) and related circuitry that are couplable to external circuitry via a plurality of bias lines 408. In one embodiment, such bias lines 408 may be the only contacts to external circuitry. More information regarding other exemplary embodiments of such differential amplifier 406 will be set forth hereinafter in greater detail during reference to subsequent figures (e.g. FIGS. 7 and 8).

With continuing reference to FIG. 3, an output of the differential amplifier 406 is coupled to output impedance matching circuitry 410. Similar to the input impedance matching circuitry 404, the output impedance matching circuitry 410 may include a multi-conductor transmission line that performs impedance transformation to match the output of the differential amplifier 406. Finally, an output transition 412 is shown to remain in communication with the output impedance matching circuit 410 for communicating amplified electromagnetic waves to the waveguide.

FIG. 5 is a side cross-sectional view of a multi-conductor transmission line 500 for impedance matching purposes taken along line 5-5 shown in FIG. 4, in accordance with an optional embodiment. As an option, the multi-conductor transmission line 500 may serve as the input impedance matching circuitry 404 and/or the output impedance matching circuitry 410 of FIG. 4. Of course, however, it should be noted that, in various embodiments, the multi-conductor transmission line 500 may be used in any desired environment. Further, the definitions provided above may equally apply to the present description.

As shown, the multi-conductor transmission line 500 is embedded in a substrate 502, whereby a pair of differential conductive lines 504 is positioned over a dielectric layer 506. In the context of an optional embodiment involving the integrated circuit 400 of FIG. 4, such differential conductive lines 504 may serve to provide a communication between the input impedance matching circuitry 404 and the input of the differential amplifier 406, and/or between the output of the differential amplifier 406 and the output impedance matching circuitry 410.

In any case, a third conductive line 508 is situated adjacent to the pair of differential conductive lines 504, forming a single-ground-signal configuration. Specifically, the third conductive line 508 may be embedded between the substrate 502 and the dielectric layer 506 such that it resides beneath the pair of differential conductive lines 504. In use, the third conductive line 508 may serve as a free-floating virtual RF ground in a device internal source (in between two gate fingers). Thus, in some embodiments, external RF grounding of the device may optionally be avoided.

By this design, the third conductive line 508 increases a capacitance per unit length associated with the pair of differential conductive lines 504. To this end, the third conductive line 508 further decreases an impedance associated with the pair of differential conductive lines 504 for facilitating impedance matching, and thus increasing result gain, etc. In some embodiments, such impedance may be decreased to 5-15 ohms.

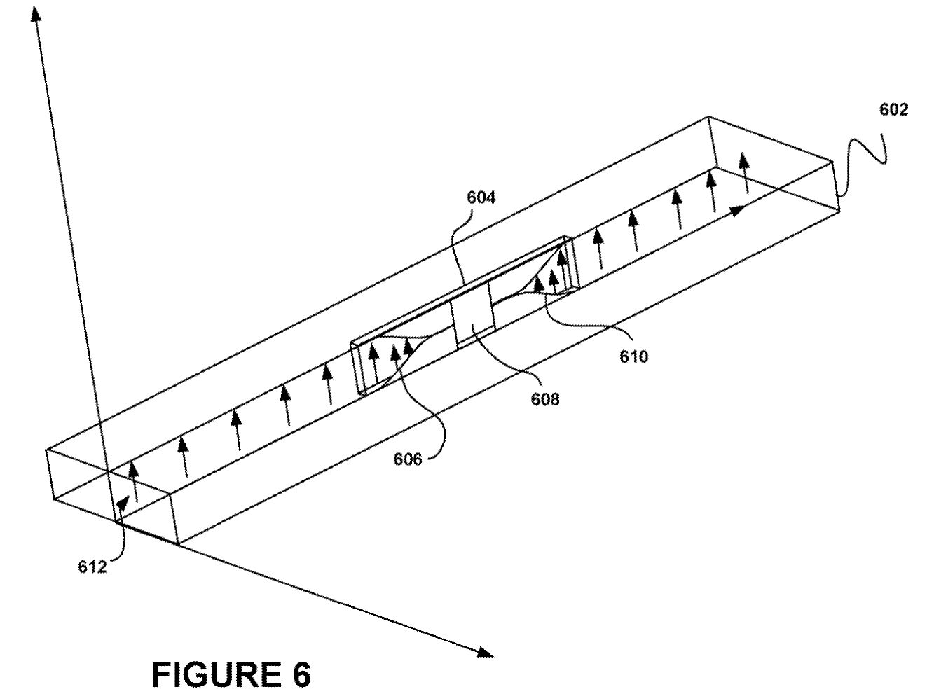

FIG. 6 is a perspective view of electromagnetic waves present during use of a waveguide 602 with an amplifying integrated circuit 604 positioned therein, in accordance with one embodiment. As an option, the electromagnetic waves may represent those present during use of the integrated circuits of FIGS. 1 and 4. Again, the definitions provided above may equally apply to the present description.

As shown the waveguide 602 includes an integrated circuit 604 which in turn, includes an input transition 606 differential amplifier 608, and output transition 610. As further shown, an electromagnetic field 612 is at a maximum strength between a top and bottom of the waveguide 602 prior to entry of the input transition 606.

Upon entering the input transition 606, the electromagnetic field 612 is guided between tapering metal plates of the input transition 606. Thereafter, the differential amplifier 608 amplifies the resultant signals for feeding the output transition 610 where the electromagnetic field 612 is reintroduced to the waveguide 602. To this end, the electromagnetic field 612 may be emitted via an output of the waveguide 602 in the manner shown.

FIG. 7 is a schematic diagram of circuitry 700 for amplifying signals in the context of a waveguide, in accordance with another embodiment. As an option, the circuitry 700 may serve the function of the amplifiers of FIGS. 1 and 4 et al. Of course, however, it should be noted that the circuitry 700 may be used in any desired environment. Further, the definitions provided above may equally apply to the present description.

Included is an amplifier circuit 702 that includes a pair of input ports 703 that remain in communication with an input transition 704. Further included is an input impedance matching double stripline 706 coupled to the input ports 703 via a pair of biasblocking capacitors 705. The input impedance matching double stripline 706 feeds a first differential transistor stage 707. Also provided is a second differential transistor stage 710 coupled to the first differential transistor stage 707 with an interstage double stripline 709 and biasblocking capacitors 708 coupled therebetween.

The second differential transistor stage 710, in turn, feeds, an output impedance matching double stripline 711 that communicates an amplified signal to a pair of output ports 713 and an output transition 714 via another pair of biasblocking capacitors 712. While not shown, the transistors of the various differential transistor stages may be configured in a drain-source-drain format (with the gates therebetween), such that the sources are centrally positioned in the integrated circuit layout, while the drains are positioned adjacent a periphery of the integrated circuit layout. Further, while not shown, additional transistor stages may be included on the integrated circuit, as desired.

In another embodiment involving an InP-HEMT amplifier, the device layout may be configured in a drain-gate-source-gate-drain electrode configuration. Further, a size of the source electrode may be reduced, since the amplifier has an internal virtual ground and does not necessarily require an external low resistance contact. In use, the source contact is only used for DC biasing purposes.

FIG. 8 is a schematic diagram of circuitry 800 for amplifying signals in the context of a waveguide, in accordance with yet another embodiment. As an option, the circuitry 800 may serve the function of the amplifiers of FIGS. 1 and 4 et al. Of course, however, it should be noted that the circuitry 800 may be used in any desired environment. Further, the definitions provided above may equally apply to the present description.

As shown, the circuitry 800 includes a first amplifying circuit 802 and a second amplifying circuit 804. As shown, in the context of one embodiment, the first amplifying circuit 802 and the second amplifying circuit 804 may take the form of the circuitry 700 of FIG. 7.

In the present embodiment, however, an incoming electromagnetic field is divided between multiple input transitions associated with the first amplifying circuit 802 and the second amplifying circuit 804. After amplification, the resultant electromagnetic waves of multiple output transitions are combined. To this end, a strength of the resultant output power may potentially be a multiple (e.g. twice, etc.) that which would be accomplished using a single amplifying circuit (e.g. see FIG. 7).

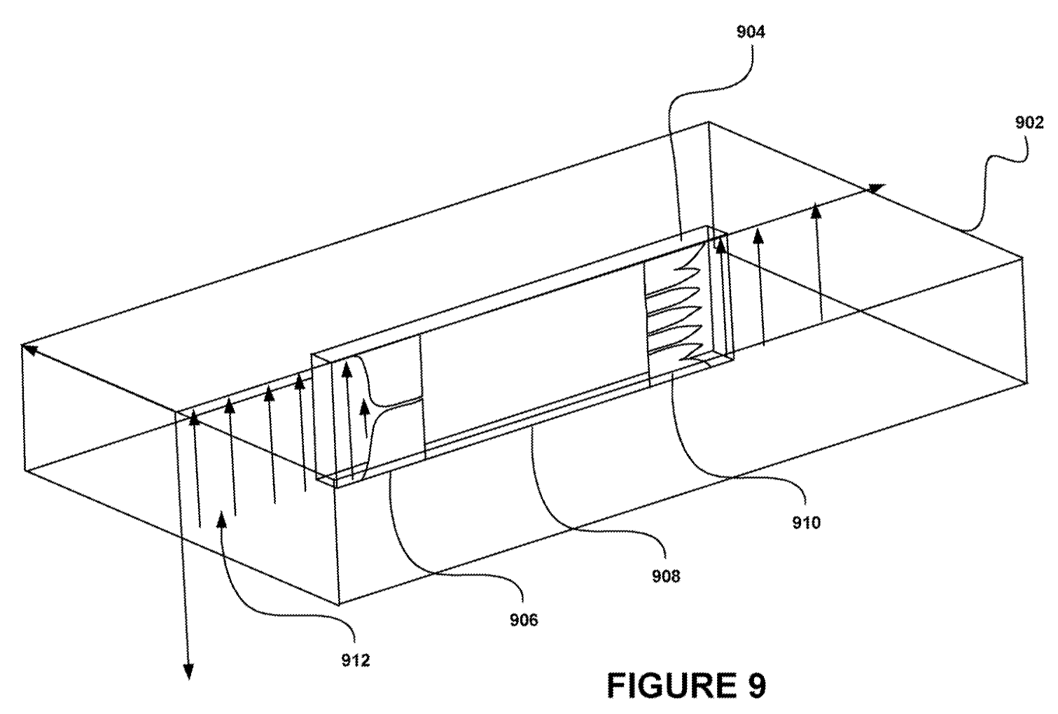

FIG. 9 is a perspective view of electromagnetic waves present during use of a waveguide 902 with an amplifying integrated circuit 904 positioned therein, in accordance with one embodiment. As an option, the electromagnetic waves may represent those present during use of the apparatus 800 of FIG. 8. Again, the definitions provided above may equally apply to the present description.

As shown, the waveguide 902 includes an integrated circuit 904 which, in turn, includes one or more input transitions 906, multiple differential amplifiers 908, and multiple output transitions 910. As further shown, an electromagnetic field 912 is at a maximum strength between a top and bottom of the waveguide 902 prior to entry of the input transition(s) 906.

Upon entering the input transition(s) 906, the electromagnetic field 912 is guided between tapering metal plates of the input transition(s) 906. Thereafter, the differential amplifiers 908 amplify the resultant signals for feeding the output transitions 910 where the electromagnetic field 912 is reintroduced to the waveguide 902. Specifically, outputs of the output transitions 910 combine the signal in phase and connect it to the output of the waveguide 902. An abrupt transition is again used. To this end, the electromagnetic field 912 may be emitted via an output of the waveguide 902 in a highly amplified manner.

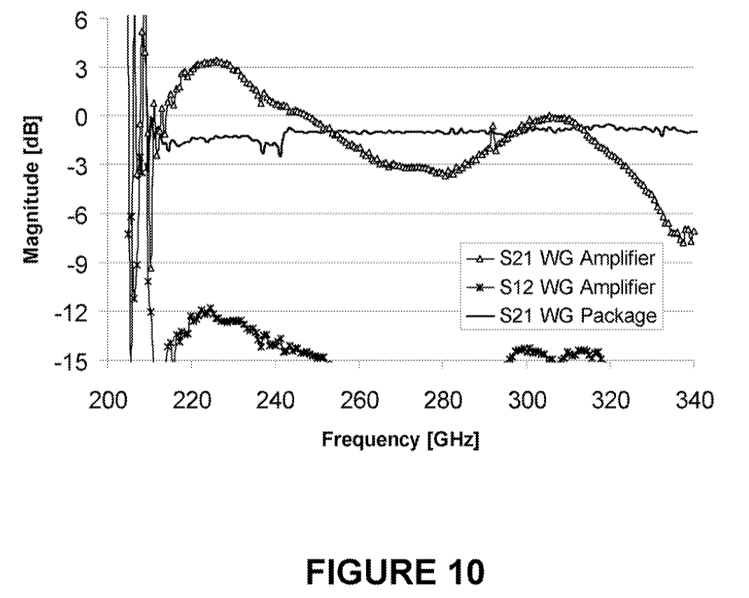

FIG. 10 illustrates a graph 1000 showing operational results for a single stage amplifier, in accordance with one embodiment. As an option, the single stage amplifier may include the various features set forth in the context of the apparatus of FIG. 1. As shown, a gain of the amplifier is 5.5 dB higher than a loss of an associated package at 230 GHz, and 0.9 dB higher at 305 GHz. Further, isolation is better than 15 dB over the waveguide (WG) band.

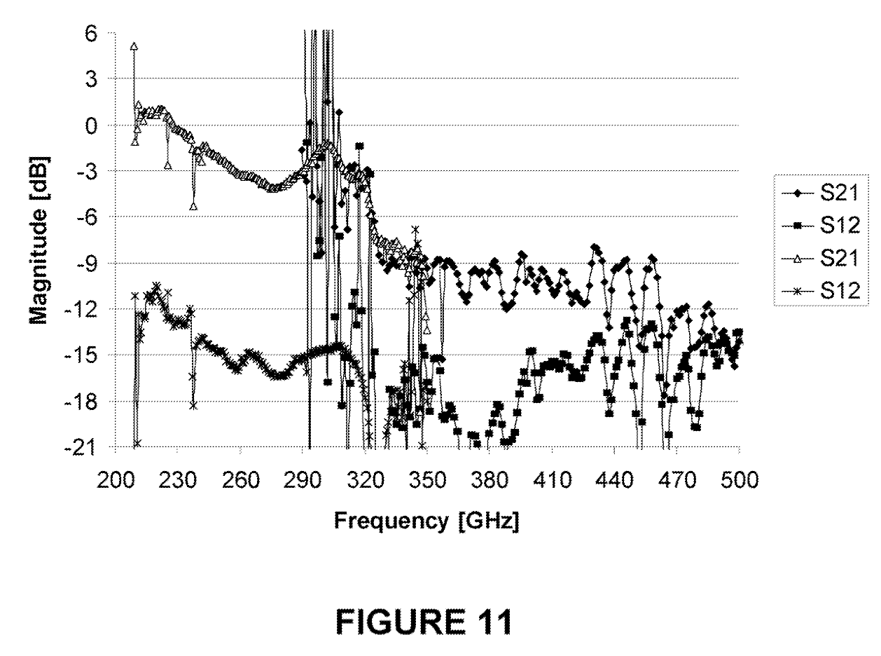

FIG. 11 illustrates a graph 1100 showing operational results for a single stage amplifier, in accordance with another embodiment. As an option, the single stage amplifier may include the various features set forth in the context of the apparatus of FIG. 1. As shown, the isolation is notable over a wide frequency band. Further, the design and packaging technique has potential for operation to at least 400 GHz when HEMT technology is available.

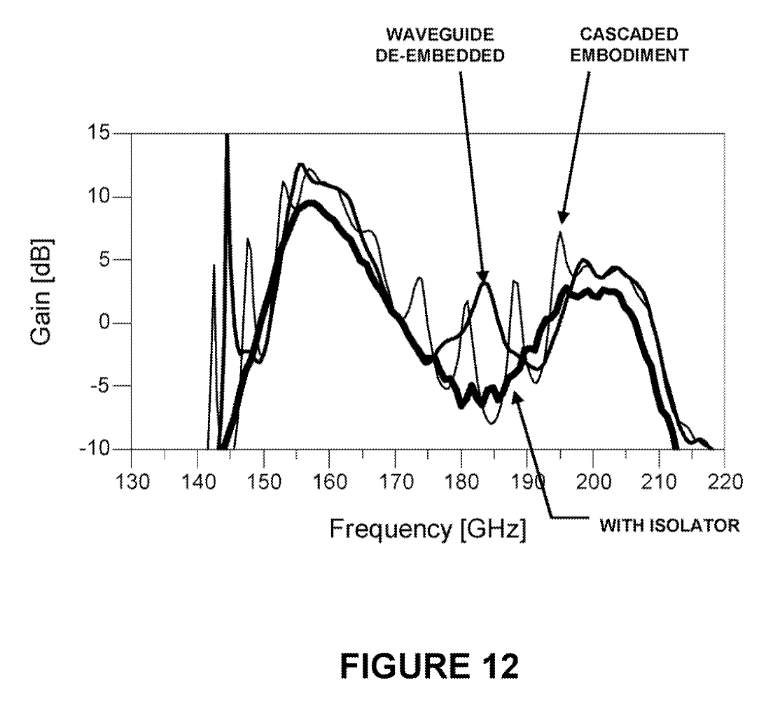

FIG. 12 illustrates a graph 1200 showing operational results for two cascaded 180 GHz integrated circuit, in accordance with yet another embodiment. As an option, the cascaded integrated circuits may be configured similar to those set forth in the context of the apparatus 300 of FIG. 3. As shown, the results of the cascaded embodiment are shown with a waveguide length between the integrated circuits being de-embedded, with an isolator, etc. Specifically, the cascading of two 180 GHz integrated circuits shows 12 dB of gain at 155 GHz, and 4.5 dB of gain at 200 GHz.

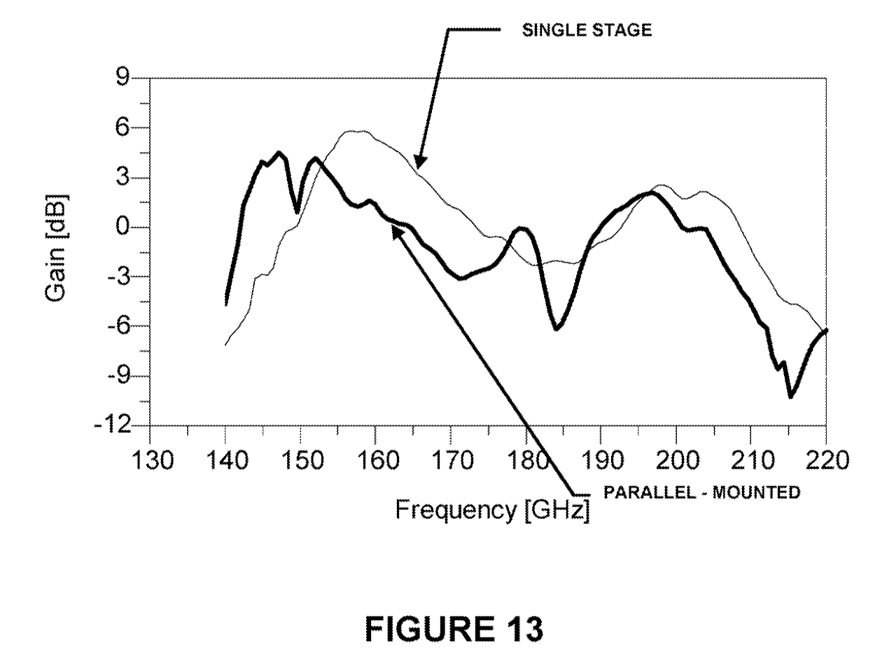

FIG. 13 illustrates a graph 1300 showing operational results for parallel-mounted integrated circuits, in accordance with another embodiment. As an option, the parallel-mounted integrated circuits may be configured similar to those set forth in the context of the apparatus 200 of FIG. 2. As shown, the results of the parallel-mounted embodiment are shown in comparison with a single stage embodiment.

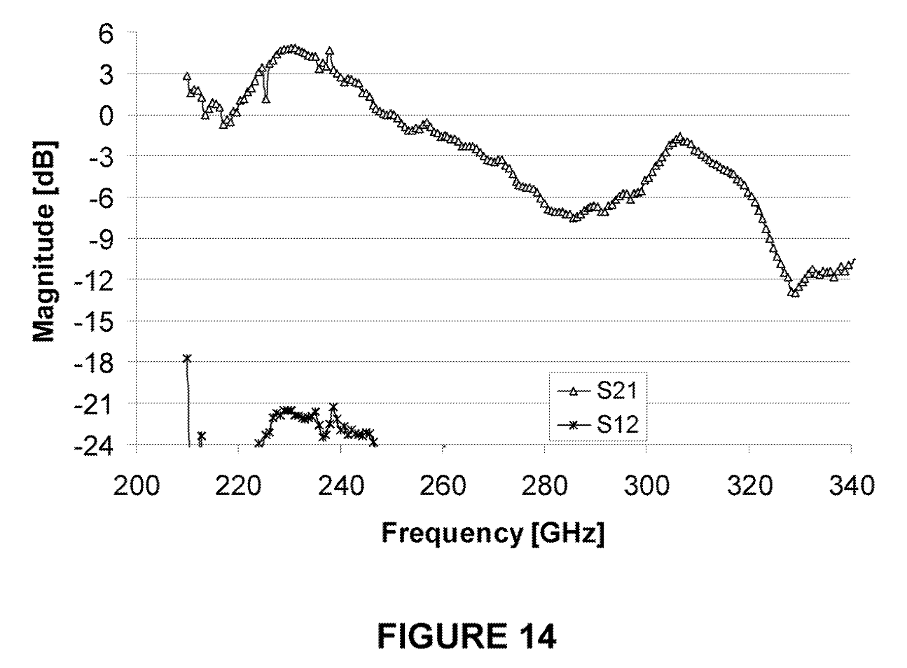

FIG. 14 illustrates a graph 1400 showing operational results for two cascaded 280 GHz integrated circuits, in accordance with yet another embodiment. As an option, the cascaded integrated circuits may be configured similar to those set forth in the context of the apparatus 300 of FIG. 3. Unlike the results of FIG. 12, the present results involve those of two 280 GHz amplifiers. As shown, the gain of the amplifier is 5.5 dB at 230 GHz, and −1.7 dB at 305 GHz. Moreover, isolation is better than 25 dB over the waveguide band.

In various embodiments involving a differential amplifier, such differential configuration may increase the input and output impedance of a transistor (e.g. by a factor of four, etc.), allowing use large transistors in power amplifiers that would otherwise have prohibitively low impedances. Still yet, one may be able to power combine an output stage with a total periphery of 180 um or larger, if desired.

In still other embodiments, the gate capacitance of a transistor may be one fourth of the original, making broadband low noise matching less challenging. As a further option, backside metallization may be avoided in any of the foregoing embodiments, since a ground plane is not necessarily required (i.e. the integrated circuit may be devoid of such ground plane, etc). Besides simplifying the integrated circuit processing, the design of various embodiments disclosed herein may reduce a parasitic capacitance of the resultant device and make it possible to mount the integrated circuit in the E-plane of the waveguide. Such E-plane packaging may exhibit low loss and may contribute to ease of assembly, because no millimeter wave wirebonds or transition substrates are necessarily required.

Even still, the use of the differential configuration may be useful in extending a frequency range of silicon CMOS into the microwave range. Also, the detrimental even (single ended) mode may be suppressed in silicon by a lossy substrate. Since, in various embodiments, there is no ground plane behind the integrated circuit, even mode impedance may be extremely high (e.g. hundreds of ohms), thus greatly reducing coupling to such mode. To this end, use of waveguide E-plane mounting techniques may be used to suppress the detrimental even (single-ended) mode and eliminate the need for lossy baluns at the input and output.

Any of the various embodiments may be suitable for numerous suitable applications. Just by way of example, resultant low noise amplifiers and power amplifiers may or may not serve as receiver front-ends for atmospheric sounders, such as a geophysical and oceanographic station for abyssal research (GeoSTAR); local oscillator drivers for high frequency heterodyne receivers in a single aperture far infrared observatory (SAFIR); so-called “origins probes;” and radar transmitter/receiver modules for entry, descent, and landing (EDL) instruments for planetary exploration. A further application may involve the Mars Atmospheric Constellation Observatory (MACO). Still additional applications may involve instruments such as a scanning microwave limb sounder (SMLS), phased array terrain radar (PATR), etc.

The foregoing description has set forth only a few of the many possible implementations. For this reason, this detailed description is intended by way of illustration, and not by way of limitations. Variations and modifications of the embodiments disclosed herein may be made based on the description set forth herein, without departing from the scope and spirit of the present application.

It is only the following claims, including all equivalents, that are intended to define the scope of the various embodiments. Moreover, the embodiments described above are specifically contemplated to be used alone as well as in various combinations. Accordingly, other embodiments, variations, and improvements not described herein are not necessarily excluded.

What is claimed is:

1. An apparatus, comprising:
a waveguide;
an integrated circuit positioned, at least in part, in the waveguide, the integrated circuit including an amplifier and at least one transition between the amplifier and the waveguide.

2. The apparatus of claim 1, wherein the waveguide includes a rectangular waveguide.

3. The apparatus of claim 1, wherein the integrated circuit is positioned in an E-plane of the waveguide.

4. The apparatus of claim 1, wherein the amplifier is a differential amplifier.

5. The apparatus of claim 1, wherein the amplifier is a millimeter wave amplifier.

6. The apparatus of claim 1, wherein the amplifier is a sub-millimeter wave amplifier.

7. The apparatus of claim 1, wherein the amplifier is an indium phosphide high electron mobility transistor (InP-HEMT) amplifier.

8. The apparatus of claim 1, wherein the amplifier includes a differentially configured transistor pair.

9. The apparatus of claim 1, wherein the amplifier includes two or more differentially configured transistor pairs.

10. The apparatus of claim 1, wherein the amplifier includes a single stage.

11. The apparatus of claim 1, wherein the amplifier includes a plurality of stages.

12. The apparatus of claim 1, wherein a plurality of the integrated circuits are positioned in the waveguide.

13. The apparatus of claim 12, wherein the waveguide provides connectivity between the integrated circuits.

14. The apparatus of claim 12, wherein the integrated circuits are situated in a side-by-side relationship.

15. The apparatus of claim 12, wherein the integrated circuits are cascaded.

16. The apparatus of claim 1, wherein the amplifier includes a pair of conductive lines and a third conductive line situated adjacent to the pair of conductive lines, and the third conductive line is situated beneath the pair of conductive lines.

17. The apparatus of claim 1, wherein the integrated circuit is devoid of a ground plane.

18. The apparatus of claim 1, wherein the at least one transition includes a slotline transition.

19. A method of processing a signal, comprising:
receiving a signal in a waveguide;
feeding the signal into a first transition integrated on an integrated circuit positioned, at least in part, in the waveguide;
amplifying the signal utilizing an amplifier integrated on the integrated circuit;
feeding the signal into a second transition integrated on the integrated circuit; and
outputting the signal from the waveguide.

20. A sub-system, comprising:
an integrated circuit capable of being positioned, at least in part, in a waveguide, the integrated circuit including an amplifier and at least one transition.
